(19) United States
(12) Patent Application Publication
(10) Pub. No.: US 2011/0289336 A1
(43) Pub. Date: Nov. 24, 2011

(54) Data transfer enabled uninterruptable power system

(75) Inventor: Hong Yu, Hollis, NH (US)

(73) Assignee: Aboundi, Inc.

(21) Appl. No.: 12/800,802

(22) Filed: May 24, 2010

(51) Int. Cl. G06F 1/30

(52) U.S. Cl. 713/340; 713/300

(57) ABSTRACT

A power mains Uninterruptable Power Source including a data transfer system according to one embodiment of the present invention comprises a data transceiver, a first data path to the power mains over which a data path is maintained, and a second data path connected to the data transceiver output and provides a data connection to data equipment connected thereto. Further embodiments provide a power mains line conditioner device have a similarly connected data transceiver, and multiple data equipment data and/or power connections, and optional internal switching features. Thus, according to the present invention, an apparatus is provided for reliable data transfer over power mains even when a typically power mains data path interrupting device, e.g. a UPS or line conditioning device is included between the data equipment and the power mains.

### FIELD OF THE INVENTION

The present invention relates to apparatus for providing back-up mains power or power mains conditioning while providing bidirectional data transmission over the power mains.

### BACKGROUND OF THE INVENTION

Devices which provide bidirectional data over power mains are operable only so long as the path of the power mains has sufficient fidelity in the range of signals that the apparatus or devices apply and receive their data signals, such as within the range of 2-10 MHz for items complying with the HomePlug™ standards and protocol. However, in many building applications, the path between power mains and data equipment passes through an Uninterruptable Power Supply (UPS) or a power line conditioner which degrades or completely interrupt the data signal path to make power mains devices which are intended to also pass data over the power main, e.g. power mains data transceivers, inoperable. Moreover, frequently the UPS devices and especially the power mains conditioning devices intentionally remove the passage of such frequencies with internal filtering to cover a broad range of expected interfering signals, or merely accidentally since prior UPS devices fail to appreciate the desirability of data transfer to the power mains.

### SUMMARY OF THE INVENTION

The power mains data transfer system according to one embodiment of the present invention comprises a data transceiver, a first data path to the power mains over which a data path is maintained, and a second, power path connected to the UPS output and provides a connection from which data transceiver operating power is derived. Various further embodiments provide multiple data equipment data and/or power connections, and optional internal switching and filtering features.

Thus, according to the present invention, an apparatus is provided for reliable data transfer over power mains even when there is a data interruption, e.g. a UPS device, there along.

### BRIEF DESCRIPTION OF THE DRAWING

These and further features of the present invention will be better understood by reading the following Detailed Description together with the Drawing, wherein

FIG. 1 is a block diagram of one embodiment of the present invention; and

FIG. 2 is a detailed block diagram of an alternate embodiment of the present invention.

### DETAILED DESCRIPTION OF EXEMPLARY EMBODIMENTS

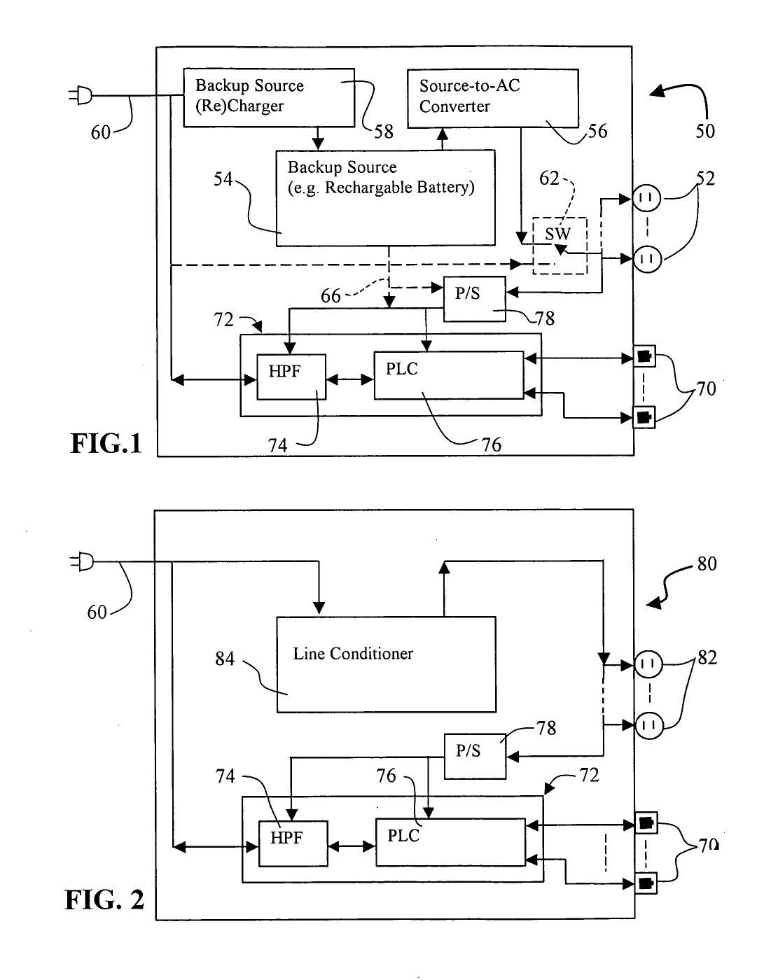

A block diagram of an exemplary embodiment 50 of a data network enabled UPS device according to the present invention is shown in FIG. 1, wherein an source of back-up AC mains power is provided at connections 52 which provides power independently of the presence of mains power to which the UPS device 50 may be connected. The back-up AC mains power is supplied by a back-up energy source 54 which has been transformed to suitable AC mains power standards, e.g. voltage, frequency, etc., by a converter 56. The back-up source 54 is envisioned to comprise a rechargeable batter, and may also include other energy sources, rechargeable or not. For rechargeable back-up sources, a (re)charger 58 provides suitable energy, e.g. voltage and current for a battery, to said back-up source 54, from power mains (not shown) to which the (re)charger is connected by connector 60. Some UPS devices may maintain the AC power at the connections 52 by power flowing only through the (re)charger 58, back-up source 54 and converter 56, while other UPS devices may include a switch 62 to provide power to the connectors 52 directly from the mains power via connector 60, e.g. a power mains plug or other suitable connector, when such mains power is available, and to switch to said converter 56—provided back-up mains power when said mains power (at connector 60) is not available. Additionally a mains power sensing circuit may be provided to activate the switch (and possibly the converter 56) to provide back-up mains power to the connectors 52 in the absence of acceptable mains power at connector 60.

A data path is provided between data equipment connectors 70, e.g. CAT-5 RJ-45 connectors or other suitable format and/or connector, and the power mains via connector 60, and is bidirectional in the exemplary embodiment, as provided by a data transceiver 72 connected to connectors 60 and 70. In the exemplary embodiment, the data transceiver 72 includes appropriate power mains interface and conditioning circuitry, e.g. a High-Pass Filter (HPF) 74 which passes data to or receives data from a Power Line Communication (PLC) engine which in turn passes data to or receives data from the equipment data connectors 70 according to data and signal format specifications currently known in the art and as may be provided in the future. Moreover, the HPF may also include or pass signals through additional circuitry (not shown) such as an Analog Front End (AFE) for further signal conversion or conditioning, and the PLC may also include or pass signals through further data circuitry (not shown) such as an ethernet switch to provide a desired routing of signals to a further plurality of data circuits via connectors 70.

A transceiver power supply (P/S) 78 receives power from the power provided to the back-up mains power connectors 52 which would include power derived from the back-up source 54 either via converter 56 or directly from the back-up source 54 via path 66. The power supply 78 transforms the received power into the appropriate voltage and currents necessary for the component elements of data transceiver 72. Alternately, the back-up source and/or the data transceiver are adapted to receive power directly from the back-up power source 54 without the power supply 78.

A second exemplary embodiment 80 of a data network enabled power mains (power line) conditioning device according to the present invention is shown in FIG. 1, wherein conditioned, e.g. filtered, voltage stabilized, transient limited, etc., AC mains power is provided by power output from a suitable line conditioner as may be available currently or in the future, at data equipment mains connections 82. The line conditioner 84 derives input power from power mains (not shown) via connector 60.

A data path is provided between data equipment connectors 70, e.g. CAT-5 RJ-45 connectors or other suitable format and/or connector, and the power mains via connector 60, and is bidirectional in the exemplary embodiment, as provided by a data transceiver 72 connected to connectors 60 and 70. In the exemplary embodiment, the data transceiver 72 includes appropriate power mains interface and conditioning circuitry, e.g. a High-Pass Filter (HPF) 74 which passes data to or receives data from a Power Line Communication (PLC) engine which in turn passes data to or receives data from the equipment data connectors 70 according to data and signal format specifications currently known in the art and as may be provided in the future. Moreover, the HPF 74 may also include or pass signals through additional circuitry (not shown) such as an Analog Front End (AFE) for further signal conversion or conditioning, and the PLC 76 may also include or pass signals through further data circuitry (not shown) such as an ethernet switch to provide a desired routing of signals to a further plurality of data circuits via connectors 70.

In the embodiment 80, a transceiver power supply (P/S) 78 receives power from the power provided from the output of the line conditioner, or may alternately receive power from the mains power via connector 60. The power supply 78 transforms the received power into the appropriate voltage and currents necessary for the component elements of data transceiver 72.

Modifications and substitutions made by one of ordinary skill in the art are within the scope of the present invention which is not to be limited except by the claims which follow.

What is claimed is:

1. An apparatus connected to power mains, comprising:
a power mains Uninterruptable Power Source (UPS) providing a back-up power mains output from a UPS backup power source;
a data transceiver having a first port, and a second, data equipment port for connection to data equipment;
a first signal path between said power mains and said transceiver first port for sending and receiving data thereover, wherein said data transceiver and said first signal path provides data flow between said power mains and said data equipment; and
means for providing operating power to said data transceiver derived from said UPS backup power source.

2. The data transfer system of claim 1, wherein said means for providing operating power comprises a power supply connected to said UPS output.

3. The data transfer system of claim 2, further including a switch having an output, which switch selectively connects said power supply to one of said power mains and said UPS output.

4. The data transfer system of claim 4, further including at least one mains outlet connected to said switch output.

5. The data transfer system of claim 1, wherein said means for providing operating power comprises a power supply connected to said UPS back-up power source.

6. The data transfer system of claim 1, further including a UPS back-up power source charger connected to said power mains and providing a flow of energy therefrom to said UPS back-up power source.

7. The data transfer system of claim 6, wherein said UPS back-up power source comprises a rechargeable battery.

8. The data transfer system of claim 7, wherein said standby power source comprises a battery.

9. A data transfer system enabled Uninterruptable Power System (UPS) for communicating data signals between data equipment and power mains, comprising:
a data transceiver having a first port, and a second port;
a first signal path between said power mains and said transceiver first port for sending and receiving data thereover;
a second signal path between said transceiver second port and said data equipment for sending and receiving data thereover;
a UPS back-up power source providing an output in the absence of power mains electrical power;
a converter connected to said back-up power source output providing a back-up power mains output, wherein
said back-up power source is further connected to provide operating power to said data transceiver, and
said data transceiver and said first and said second signal path provides data flow between said power mains and said data equipment.

10. An apparatus connected to power mains, comprising:
a power mains line conditioner providing a conditioned power mains output from a power mains input;
a data transceiver having a first port, and a second, data equipment port for connection to data equipment;
a first signal path between said power mains and said transceiver first port for sending and receiving data thereover, wherein said data transceiver and said first signal path provides data flow between said power mains and said data equipment; and
means for providing operating power to said data transceiver derived from one of said power mains and said conditioner power mains output.

11. The data transfer system of claim 10, wherein said means for providing operating power comprises a power supply connected to one of said power mains and said conditioner power mains output.
